(19) United States
(12) Patent Application Publication
(10) Pub. No.: US 2006/0039829 A1
(43) Pub. Date: Feb. 23, 2006

(54) Microfluidic device, and diagnostic and analytical apparatus using the same

(76) Inventors: Ji Won Suk, Seoul (KR); Jae Kwon Kim, Goyang-city (KR); Ja Hoon Jeong, Daejeon-city (KR); Sang Phil Han, Daejeon-city (KR); Yehoon Im, Daejeon-city (KR); Youngduk Kim, Daejeon-city (KR)

Correspondence Address: MCKENNA LONG & ALDRIDGE LLP, 1900 K STREET, NW, WASHINGTON, DC, 20006, US

(21) Appl. No.: 11/206,087

(22) Filed: Aug. 18, 2005

(30) Foreign Application Priority Data
Aug. 21, 2004 (KR) 10-2004-0066171
Aug. 21, 2004 (KR) 10-2004-0066166

(51) Int. Cl. G01N 27/26

(52) U.S. Cl. 422/100; 204/601

(57) ABSTRACT

A diagnostic and analytical apparatus including the microfluidic device having: an inlet portion with a first cross-section, a flow delaying portion with a second cross-section that is larger than the cross-section of the inlet portion thereby reducing the interfacial curvature of the microfluid entering from the inlet portion by capillary force and the flow rate of the microfluid, and a flow recovery portion having a third cross-section that is smaller than the cross-section of the flow delaying portion. The flow of a very small volume of fluid can be quantitatively regulated through a channel having a particular design that can induce spontaneous flow by capillary force without additional manipulation processes and energy requirement.

### CROSS-REFERENCE TO RELATED PATENT APPLICATION

This application claims the benefit of Korean Patent Application Nos. 10-2004-0066166, and 10-2004-0066171, both filed on Aug. 21, 2004, in the Korean Intellectual Property Office, the disclosures of which are incorporated herein in their entirety by reference.

### BACKGROUND OF THE INVENTION

1. Field of the Invention

The present invention relates to a microfluidic device and a diagnostic and analytical apparatus using the same, and more particularly, to a microfluidic device which can quantitatively regulate a very small volume of fluid in capillary flow and a diagnostic and analytical apparatus using the same.

2. Description of the Related Art

Microfluidic technologies for inducing and controlling the flow of very small volumes of fluid are essential to the driving of diagnostic and analytical apparatuses. Such technologies can be implemented using various driving methods. Typical driving methods include a pressure-driven method of pressing a fluid injection portion, an electrophoretic method or electroosmotic method of transferring fluid by applying a voltage across a microchannel, a capillary flow method using capillary force, etc.

A typical example of a microfluidic device using the pressure-driven method of applying pressure is disclosed in U.S. Pat. No. 6,296,020. The microfluidic device disclosed in U.S. Pat. No. 6,296,020 is a hydrophobic fluidic circuit device using a passive valve to control the cross-sectional area of a channel and hence the hydrophobicity of the channel. U.S. Pat. No. 6,637,463 discloses a microfluidic device including a plurality of channels with pressure gradients to uniformly distribute fluid through the channels.

Meanwhile, the capillary flow method using a capillary phenomenon spontaneously occurring in microchannels is advantageous in that a very small volume of fluid near a fluid injection portion can be spontaneously and instantly moved along a channel without the need for an additional device. Therefore, much research has been conducted to design microfluidic systems using the capillary flow method. U.S. Pat. No. 6,271,040 discloses a diagnostic biochip in which a sample is transferred using only natural capillary flow in microchannels without using a porous substance, a reaction with the sample is induced, and a particular component in the sample is detected using an optical method. U.S. Pat. No. 6,113,855 discloses a diagnosing apparatus in which hexagonal pillars for transferring a sample between two sites are properly arranged to generate a capillary force.

However, in such conventional microfluidic devices and diagnostic and analytical apparatuses using the same, despite the need for designing microchannels that can reduce the total time of analysis and in which the flow rate can be reduced in a section where reactions take place at a particular point in time to allow the sample sufficient reaction time and can be increased at a particular point in time to wash away the reaction product for identification, little research into such microchannels has been conducted.

To address this issue, a method of partially strengthening or weakening the surface tension or partially varying the surface energy on a capillary wall to change the contact angle can be considered. However, this method requires an additional device or operation.

### SUMMARY OF THE INVENTION

The present invention provides a microfluidic device in which the flow of a very small volume of fluid can be quantitatively regulated through a channel having a particular design that can induce spontaneous flow by capillary force without additional manipulation processes and energy requirement. The microfluidic device can be easily manufactured and can be easily used. The present invention also provides a diagnostic and analytical apparatus using the microfluidic device.

According to an aspect of the present invention, there is provided a microfluidic device having a microchannel through which a microfluid flows, the device comprising: an inlet portion through which the microfluid flows and which has a first cross-section and a predetermined length; a flow delaying portion which is located adjacent to the inlet portion to allow the microfluid from the inlet portion to enter, has a second cross-section that is larger than the first cross-section of the inlet portion to reduce the interfacial curvature of the microfluid entering from the inlet portion by capillary force and the flow rate of the microfluid, and has a predetermined length extending in a direction in which the microfluid flows; and a flow recovery portion which is located adjacent to the flow delaying portion to allow the microfluid from the flow delaying portion to enter, and has a third cross-section that is smaller than the second cross-section of the flow delaying portion and a predetermined length.

The predetermined length of the flow delaying portion may be smaller than a width of the flow delaying portion.

The first cross-section may be fixed through the inlet portion, the second cross-section may be fixed through the flow delaying portion, and the third cross-section may be fixed through the flow recovery portion.

Lengthwise walls of the inlet portion and widthwise walls of the flow delaying portion may form an angle in a range of 45-90 degrees.

The second cross-section of the flow delaying portion may have the same height as the first cross-section of the inlet portion and a width that is larger than the first cross-section of the inlet portion. The width of the second cross-section of the flow delaying portion may be three times larger than a width of the first cross-section of the inlet portion.

The second cross-section of the flow delaying portion may have the same width as the first cross-section of the inlet portion and a height that is larger than the first cross-section of the inlet portion. The height of the second cross-section of the flow delaying portion may be two times larger than the first cross-section of the inlet portion, and upper surfaces of the second cross-section and the first cross-section may be on the same plane.

The first cross-section of the flow delaying portion and the third cross-section of the flow recovery portion may be the same.

The microfluidic device may further comprise: an inflow portion into which the microfluid from the flow recovery portion flows and which has a fourth cross-section; a cross-section enlarging portion into which the microfluid from the inflow portion flows and which has cross-sections varying from the fourth cross-section to a fifth cross-section, which is larger than the fourth cross-section, and a predetermined length; and a flow accelerating portion which has substantially the same cross-section as the fifth cross-section.

The flow accelerating portion may include at least one acceleration wall arranged at interval in the widthwise direction and extending along the lengthwise direction in which the microfluid flows, forming a plurality of acceleration channels.

A front end of the acceleration wall near the cross-section enlarging portion may be shaped such that the microfluid incoming from the cross-section enlarging portion can easily branch off to flow into the plurality of acceleration channels.

The acceleration wall may be a thin plate arranged in the lengthwise direction of the flow accelerating portion.

Surfaces of the acceleration channels in the flow accelerating portion may be hydrophilically treated.

The inflow portion may be a channel connected to a detection unit in which capture antibodies that are reacted with the microfluid are fixed.

According to another aspect of the present invention, there is provided a diagnostic and analytical apparatus using the above-described microfluidic device.

The present invention provides a diagnostic and analytical apparatus including a plurality of microfluidic devices with microchannels through which a microfluid flows, the apparatus comprising: a main channel through which the microfluid flows; and a plurality of branch control units which are connected to the main channel and branch off the microfluid from the main channel to flow into the plurality of microfluidic devices, wherein each of the branch control units comprises: a sub-channel which is connected to the main channel and has a first cross-section that is smaller than a cross-section of the main channel; a flow delaying portion which is connected to the sub-channel to allow the microfluid from the sub-channel to enter, has a second cross-section that is larger than the first cross-section of the sub-channel to reduce the interfacial curvature of the microfluid entering from the sub-channel by capillary force and the flow rate of the microfluid, and has a predetermined length extending in a direction in which the microfluid flows; and a flow recovery portion into which the microfluid from the flow delaying portion flows and has a third cross-section that is smaller than the second cross-section of the flow delaying portion.

The sub-channels which are located upstream from the main channel may have larger cross-sectional areas than the sub-channels which are located downstream from the main channel such that the microfluid flowing along the main channel can almost simultaneously reach the individual microfluidic channels.

A larger number of branch control units may be located upstream from the main channel than downstream from the main channel such that the microfluid flowing along the main channel can almost simultaneously reach the individual microfluidic channels.

The sub-channels which are located upstream from the main channel may be longer than the sub-channels which are located downstream from the main channel such that the microfluid flowing along the main channel can almost simultaneously reach the individual microfluidic channels.

At least one acceleration wall may be installed lengthwise in the main channel to increase the capillary force of the microfluid flowing along the main channel such that the microfluid can almost simultaneously reach the individual microfluidic channels.

The diagnostic and analytical apparatus may further comprise: outlet microchannels which are respectively connected to the microfluidic devices; flow stoppage channels which are respectively connected to ends of the outlet microchannels to stop the microfluid from flowing; and a discharge channel which is connected to the flow stoppage channels and externally discharges air in the microfluidic devices through the outlet microchannels.

Each of the microfluidic devices may comprises: an inlet portion into which the microfluid from the corresponding sub-channel flows and which has a fourth cross-section and a predetermined length; a flow delaying portion which is located adjacent to the inlet portion to allow the microfluid from the inlet portion to enter, has a fifth cross-section that is larger than the first cross-section of the inlet portion to reduce the interfacial curvature of the microfluid entering from the inlet portion by capillary force and the flow rate of the microfluid, and has a predetermined length extending in the direction in which the microfluid flows; and a flow recovery portion which is located adjacent to the flow delaying portion to allow the microfluid from the flow delaying portion to enter, and has a sixth cross-section that is smaller than the fifth cross-section of the flow delaying portion and a predetermined length.

Each of the microfluidic devices may comprise: an inflow portion into which the microfluid from the flow recovery portion flows and which has a fourth cross-section; a cross-section enlarging portion into which the microfluid from the inflow portion flows and which has cross-sections varying from the fourth cross-section to a fifth cross-section, which is larger than the fourth cross-section, and a predetermined length; and a flow accelerating portion which has substantially the same cross-section as the fifth cross-section.

The inflow portion may be a channel connected to a detection unit in which capture antibodies that are reacted with the microfluid flowing through the flow recovery portion are fixed.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional microchannel;

FIG. 2 is a graph of pressure distribution variation in capillary flow versus time;

FIG. 3 is a conceptual view illustrating a flow delay principle of a flow delaying model depending on interface curvature variation;

FIG. 4A is a schematic view of a microfluidic device according to a first embodiment of the present invention;

FIG. 4B is a schematic view of a microfluidic device according to a second embodiment of the present invention;

FIG. 4C is a schematic view of a microfluidic device according to a third embodiment of the present invention;

FIG. 4D is a schematic view of a microfluidic device according to a fourth embodiment of the present invention;

FIGS. 5A through 5F illustrate microfluidic devices having various cross-sectional shapes according to embodiments of the present invention;

FIG. 6 is photographs showing flow delays in the flow delaying model in FIG. 5A;

FIG. 7A is a schematic view of a microfluidic device using a flow acceleration model when the primary length ratio in the capillary tube is maintained constant and the secondary length ratio is increased;

FIG. 7B is a schematic view of a flow acceleration model with internal walls inserted in a region of FIG. 7A where an interface is located;

FIG. 8A is a graph of pressure distribution versus time when a flow cross-sectional area is increased;

FIG. 8B is a graph of flow rate versus time in each region when the flow cross-sectional area is increased;

FIG. 8C is a graph of flow rate versus time in a region (D1) when internal walls are inserted in a flow acceleration model to raise the interfacial pressure;

FIG. 8D is a graph illustrating influence of the number of inserted walls on velocity;

FIG. 9A is a schematic view of a microfluidic device using a flow acceleration model according to a first embodiment of the present invention;

FIGS. 9B and 9C are schematic views of flow acceleration models according to second and third embodiments of the present invention, in which structures in various shapes are inserted to increase the capillary force;

FIG. 10 is a schematic view of a diagnostic and analytical apparatus according to a first embodiment of the present invention, which uses flow delaying models and a flow acceleration method according to the present invention;

FIG. 11 is a schematic view of a diagnostic and analytical apparatus according to a second embodiment of the present invention, which includes a flow branch model using flow delaying models according to the present invention; and

FIG. 12 is a schematic view of a multi-diagnostic and analytical apparatus according to a third embodiment of the preset invention using flow delaying models, a flow acceleration mode, a flow branch model according to the present invention.

### DETAILED DESCRIPTION OF THE INVENTION

The present invention will now be described more fully with reference to the accompanying drawings.

The present invention relates to effectively decreasing or increasing in a particular region the flow rate of a fluid, which flows due to capillary phenomenon. A model equation describing the relationship between pressure variation and the contact angle at a gas-liquid interface, which cause capillary flow, will be summarized, and the principles of designing a flow delaying model and a flow acceleration model based on the model equation will be described.

Capillary flow is induced by discontinuous variations in pressure at a gas-liquid interface, which occur when the interface is curved. The interfacial curvature is caused by a contact angle (θ) between the gas-liquid interface and a solid wall surface, i.e., at a triple point of the gas-liquid interface and the solid wall surface. In general, the contact angle (θ) refers to an angle between the wall surface and a liquid side of the gas-liquid interface. When the wall surface is closer to the liquid than the gas, the contact angle (θ) is between 0 and π/2, otherwise, the contact angle is between π/2 and π. When the cross-section of a channel through which liquid flows is rectangular, if the corner effect of the channel and a flow effect are ignored, a change in pressure in the fluid can be expressed as follows:
ΔP=P₀−Pₐ=γ(1/b+1/c)cos θ (1)
where P₀ is an initial pressure of the fluid, Pₐ is a pressure of the fluid when flowing, b is the depth of the channel, c is the width of the channel (b<c), and θ is the contact angle.

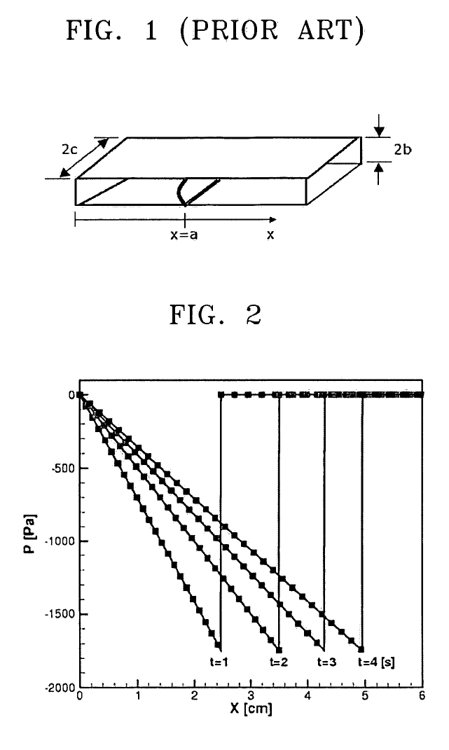

FIG. 1 is a schematic view of a conventional microchannel. Such a general microchannel as shown in FIG. 1 is manufactured with a depth and a width each ranging from tens to hundreds of micrometers. Considering their degrees of contribution to the change in pressure (ΔP), “b” can be referred to as a primary length, and “c” can be referred to as a secondary length. The change in pressure (ΔP) at the interface depends on the position (a) of the interface and a resulting pressure gradient ΔP/a induces flow of the fluid. The flow of the fluid belongs to a laminar flow region. The pressure gradient, the resistive force against the channel wall, Π, and the flow rate, V, satisfy the following relation:
V=(ΔP/a)·Π (2)

In a channel having a rectangular cross-section, the resistive force, Π, can be expressed by the primary length (b) and the secondary length (c) as follows:

$$Π = \frac{{b}^{2}}{3} - \frac{{2}^{6} {b}^{3}}{{π}^{5} c} {\sum }_{n = 1}^{∞} \frac{1}{{n}^{5}} {sin}^{2} ( \frac{n π}{2} ) tanh ( \frac{n π c}{2 b} ) \qquad ( 3 )$$

With the assumption of a pseudo normal state, the following ordinary differential equation for the interfacial position can be obtained.

$$\frac{ⅆ a}{ⅆ t} = V \qquad ( 4 )$$

When the channel has a constant, rectangular cross-section as shown in FIG. 1, the theoretical solutions for the interfacial position, flow rate, and pressure distribution can be obtained. FIG. 2 is a graph of pressure distribution in capillary flow versus time at 2b=50 μm, 2c=200m, Y=0.07N/m, and θ=π/3. In FIG. 2, a section in which the slope of the pressure curve is negative corresponds to a liquid region, a section in which there is no change in pressure corresponds to a gas region, and points at which the slope of the pressure curve abruptly changes correspond to interfacial positions. Flow generated in response to the pressure variation in the liquid region shifts the interfacial position, and the slope of the pressure variation becomes smoother as the interfacial position shifts. Accordingly, the interfacial position shifting rate decreases over time.

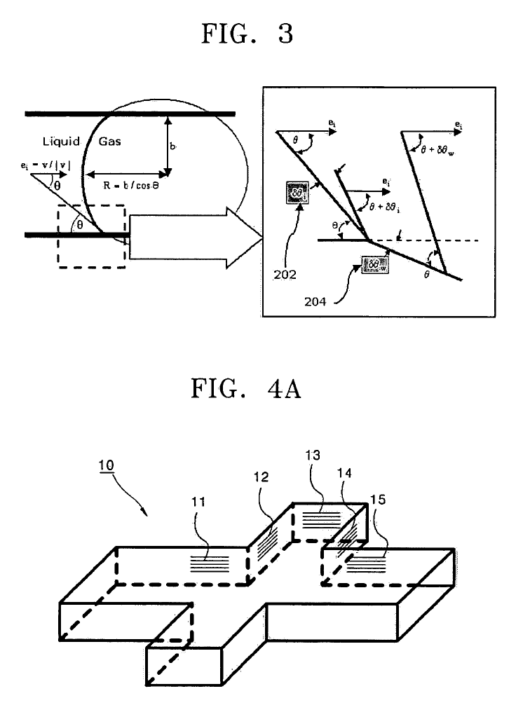

A main idea involved in constructing the flow delaying model according to the present invention is a reduction in the pressure variation (ΔP), and in particular, a delay in the flow in a particular area by curving a portion of the wall surface adjacent to the primary or secondary length to effectively control the interfacial curvature. FIG. 3 is a conceptual view illustrating a flow delay principle in a flow delaying model depending on interfacial curvature variation. As shown in FIG. 3, in the case of a semi-circular interface, the interfacial curvature that induces the pressure variation (ΔP) at the interface is proportional to the cosine of an angle between a tangent of the interface at a contact point with the wall surface and a forward direction (ei) of the interface. In this case, when the wall surface is straight, the angle between the tangent of the interface at the contact point with the wall surface and the forward direction (ei) of the interface equals the contact angle (θ) between the interface and the wall surface. The interfacial curvature, i.e., the angle between the tangent of the interface at the contact point with the wall surface and the forward direction (ei) of the interface can be varied by δθw 204 or δθi 202 in FIG. 3. To vary the angle by δθi 202, the thermodynamic state of a constituent material of the wall surface has to vary, and thus an additional process must be performed on a particular wall surface when designing a channel. Meanwhile, to vary the angle by δθw 204 by curving the wall surface of a channel, the channel can be easily manufactured using, for example, photolithography, without additional processes. The former method of varying the interfacial curvature by varying the angle by δθi 202, which is associated with the physical properties of the wall surface, has limited applications, while the latter method of varying the interfacial curvature by varying the angle by δθw 204 has a wide range of applications. In the present invention, the latter method is used.

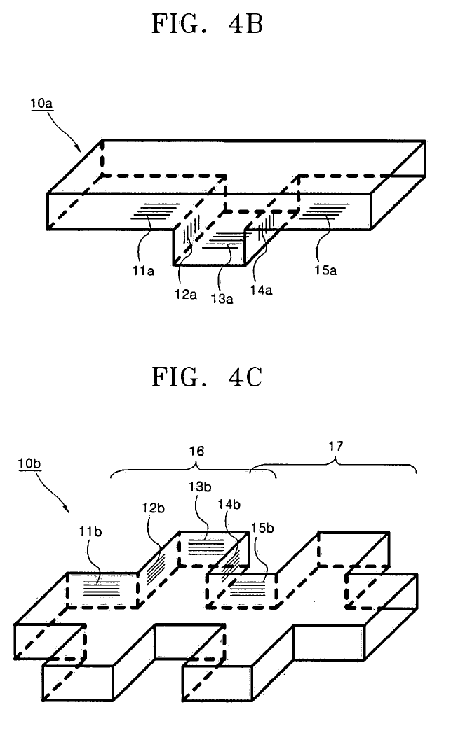

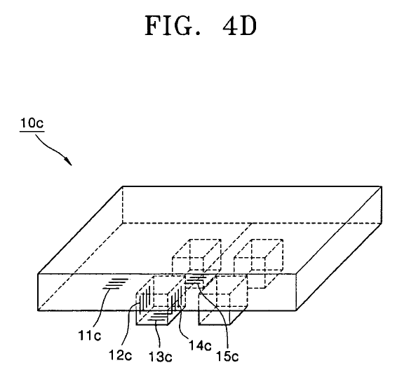

FIG. 4A is a schematic view of a microfluidic device using a flow delaying model according to a first embodiment of the present invention. FIG. 4B is a schematic view of a microfluidic device using a flow delaying model according to a second embodiment of the present invention. In the microfluidic device according to the first embodiment of the present invention, a flow delaying model having a curved wall surface obtained by changing the secondary length of a microchannel is used. In the microfluidic device according to the second embodiment of the present invention, a flow delaying model having a curved wall surface obtained by changing the primary length of a microchannel is used. As shown in FIGS. 4A and 4B, the microfluidic devices 10 and 10a respectively include: inlet portions 11 and 11a through which a microfluid flows, each of which has a first cross-section and a predetermined length; flow delaying portions 13 and 13a respectively located next to the inlet portions 11 and 11a to allow the microfluid from the inlet portions 11 and 11a to enter, each of the flow delaying portions 13 and 13a having a second cross-section that is larger than the first cross-sections of the inlet portions 11 and 11a to reduce the interfacial curvature of the microfluid incoming from the inlet portions 11 and 11a by capillary force and thus the flow rate of the microfluid; and flow recovery portions 15 and 15a respectively located next to the flow delaying portions 13 and 13a to allow the microfluid from the flow delaying portions 13 and 13a to enter, each of the flow recovery portions 15 and 15a having a third cross-section that is smaller than the second cross-sections of the flow delaying portions 13 and 13a and a predetermined length.

Capillary flow is delayed in respective delaying boundary regions 12 and 12a between the inlet portions 11 and 11a and the flow delaying portions 13 and 13a. The effect of delaying the capillary flow is maintained through the delaying boundary regions 12 and 12a. The capillary flow passing through the delaying boundary regions 12 and 12a flows through the flow delaying portions 13 and 13a and reaches respective recovery boundary regions 14 and 14a between the flow delaying portions 13 and 13 and the flow recovery portions 15 and 15a. When the capillary flow reaches the recovery boundary regions 14 and 14a, the interfacial curvature increases and the fluid starts to recovery the initial flow rate. The initial flow rate is completely recovered while the fluid flows through the flow recovery portions 15 and 15a.

In the above-described embodiments, the flow recovery portions 15 and 15a at the ends of the curved wall surfaces are designed with the same flow sectional area as the inlet portions 11 and 11a. This allows the capillary flow passing through the flow delaying model, which temporarily delays the flow in a particular region at a particular point in time, to recover the initial flow rate of the fluid as before it enters the flow delaying model to comply with the purpose of the flow delaying model. As described above, this flow delaying effect can be obtained by varying the angle of the wall surface.

When the wall surface of a microfluidic device curves at 90 degrees as illustrated in FIGS. 4A and 4B, to prevent stopping of the capillary flow, at least one of four sides surrounding the fluid has to be formed to be planar. In general, the length of the flow delaying portions 13 (13a) has to be smaller than the width thereof to allow continuous flow. In addition, although in the above-described embodiments the first cross-section of the inlet portion 11 (11a), the second cross-section of the flow delaying portion 13 (13a), and the third cross-section of the flow recovery portion 15 (15a) have fixed shapes, the shapes of the first, second, and third cross-sections may vary in a direction in which the fluid flows. The walls of the inlet portion 11 (11a) extending in the lengthwise direction thereof are formed to be perpendicular to the walls of the flow delaying portion 13 (13a) in the widthwise direction thereof. In the first embodiment illustrated in FIG. 4A, the second cross-section has the same height as the first cross-section and about three times wider width than the first cross-section. In the second embodiment illustrated in FIG. 4B, the second cross-section has the same width as the first cross-section and two times greater height than the first cross-section, wherein the upper surface of the second cross-section levels with the upper surface of the first cross-section.

Although, in the embodiment of FIG. 4B where the curved wall surface is formed by varying the primary length, only one surface is curved while the remaining three surfaces are maintained to be straight, to ensure sufficient hydrophilicity for continuous capillary flow, the flow delaying portion may be formed by varying only the secondary length to obtain the curved wall surface while maintaining the primary length. The flow delaying effect can be controlled by varying the area of each portion. In other words, when the capillary flow continues through more delay boundary portions 12 (12a), due to an increase in flow sectional area, a great flow delaying effect can be obtained. Therefore, it is advantageous to obtain the curved wall surface by periodically forming flow delaying portions with large widths and small lengths to repeatedly induce the flow delaying effect. In other words, when designing a flow delaying model, forming a plurality of short flow delaying portions, rather than forming one long flow delaying portion, is advantageous. In this case, a quantitative flow delaying effect can be obtained by varying the number of flow delaying portions.

FIG. 4C is a schematic view of a microfluidic device according to a third embodiment of the present invention. In the microfluidic device according to the third embodiment of the present invention, two flow delaying models are connected in series. In FIG. 4C, “b”s are added to the reference numerals denoting the constituent elements described in the first embodiment. Capillary flow induced in an inlet portion 11b is delayed by a first flow delaying model 16 and then by a second flow delaying model 17. A flow recovery portion 15b of the first flow delaying model 16 serves as an inlet portion of the second flow delaying model 17. By connecting the two flow delaying models 16 and 17 in series, the flow delaying effect can be controlled.

FIG. 4D is a schematic view of a microfluidic device according to a fourth embodiment of the present invention, in which flow delaying models each having the structure of FIG. 4B are arranged in a 2×2 array. In FIG. 4D, “c”s are added to the reference numerals denoting the constituent elements described in the first embodiment. The flow delaying models may have various shapes, for example, hexahedron shapes, as illustrated in FIG. 4D, cylindrical shapes, etc. The flow delaying effect can be controlled by varying the sizes, number, and interval of the flow delaying models.

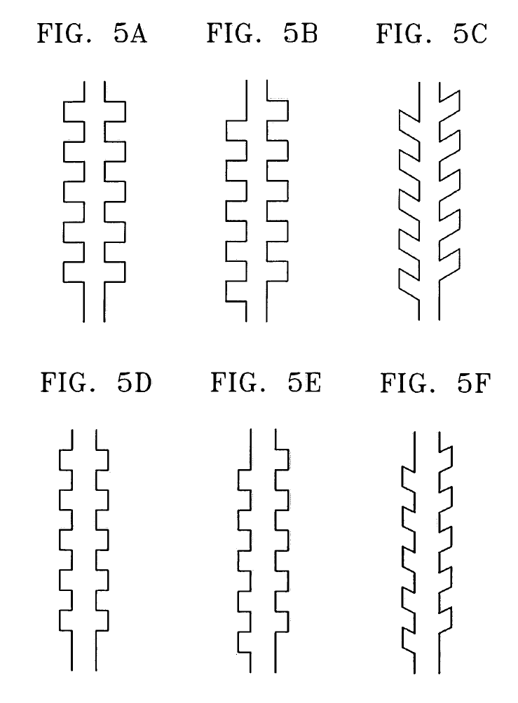

FIGS. 5A through 5F illustrate various cross-sectional shapes of microfluidic devices according to embodiments of the present invention. In these embodiments, the shapes and sizes of the delaying boundary portions, the flow delaying portions, and the recovery boundary portions connected to rectangular microchannels are varied to control the flow delaying effect. In a flow delaying model of FIG. 5A, as in the above-described first through third embodiments illustrated in FIGS. 4A and 4C, the delaying boundary portions extend from both sidewalls of an inlet portion at right angles, and the flow delaying portion has a rectangular shape. In a flow delaying model of FIG. 5B, a delay boundary portion extends at a right angle from one sidewall near the inlet portion and another delay boundary portion extends at a right angle from an opposite sidewall downstream from the first boundary portion in a staggered fashion such that the flow is alternately delayed by delaying boundary portions on either side of the microchannel. The flow delaying model in FIG. 5B induces a smaller delay effect than the flow delaying model in FIG. 5A. In a flow delaying model of FIG. 5C, a delaying boundary portion extends at an acute angle from one sidewall near the inlet portion and another delaying boundary portion extends at an acute angle from an opposite sidewall downstream from the first boundary portion in a staggered fashion. The flow delaying portions have trapezoidal shapes. Since the inlet portion and the delaying boundary portions form acute angles, the flow delaying effect of the flow delaying model of FIG. 5C is greater than the flow delaying model of FIG. 5B. In the flow delaying models in FIGS. 5D through 5F, the flow delaying portions have narrower widths than the flow delaying portions of the flow delaying models in FIGS. 5A through 5C. Accordingly, the cross-sectional areas of extended portions of the flow delaying portions in FIGS. 5D through 5F are smaller than those of the flow delaying portions in FIGS. 5A through 5C. Therefore, the flow delaying effects of the flow delaying models in FIGS. 5D through 5F are smaller than those of the flow delaying models in FIGS. 5A through 5C.

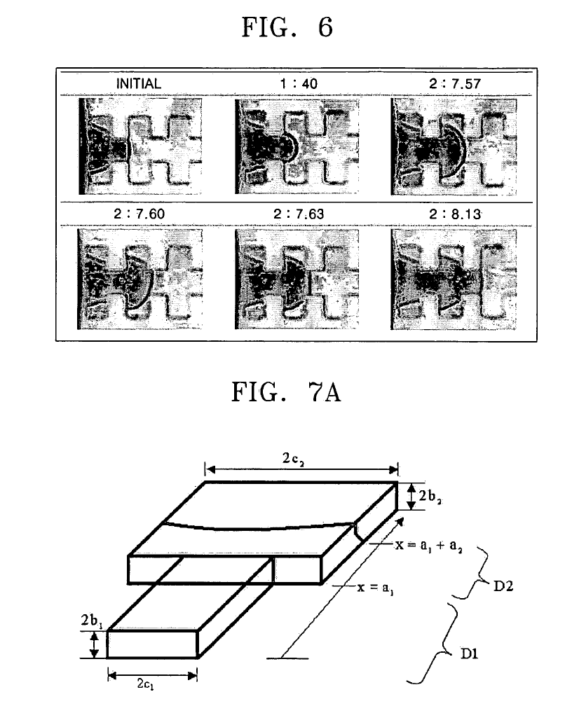

FIG. 6 is photographs showing a flow delaying effect of the flow delaying model in FIG. 5A manufactured by combining a first plate with a depressed pattern with a flat second plate. In particular, after manufacturing a mold with an embossed pattern corresponding to the shape of a flow delaying model, polydimethylsiloxane (PDMS) is cast into the mold to obtain the first plate with the depressed pattern. The first plate is holed to obtain an inlet hole for injecting the fluid from the outside and an outlet hole for discharging the fluid to the outside. The first plate and the second plate formed of polymethylmethacrylate (PMMA) are surface-treated to control their hydrophilicities, and then combined together. After the surface treatment, the first plate has a water contact angle of 56°, and the second plate formed of PMMA has a water contact angle of 75°.

A solution prepared by dissolving Procion Red MX-5B (Aldrich Chemical Company, Inc.), which is a dye, in ultra pure water was injected into the flow delaying model having the structure of FIG. 5A. As described above, the flow of the fluid injected into the flow delaying model was delayed while passing through the flow delaying model. Referring to FIG. 6, the flow rate of the fluid that had reached the delaying boundary region through the inlet portion of the flow delaying model was markedly reduced (the photograph taken at an “INITIAL” stage in FIG. 6). The flow delaying effect was maintained while the fluid passed the delaying boundary region (the photographs taken at 1 min 40.00 sec and 2 min 7.57 sec in FIG. 6). However, when the fluid reached the recovery boundary portion 14 (14a), the flow delaying effect did not occur any longer, and the initial flow rate of the fluid in the inlet portion was recovered (the photographs taken at 2 min 7.60 sec and 2 min 7.63 sec in FIG. 6). It took 0.5 seconds, from 2 min 7.63 sec to 2 min 8.13 sec, for the fluid to flow through the recovery boundary portion 14 (14a) to the flow recovery portion. Through the comparison with the delay time, i.e., 2 min 7.57 sec, in the flow delaying portion, the flow delaying effect in the flow delaying portion can be confirmed.

In the flow delaying model in FIG. 6, the fluid does not fully fill the flow delaying portions and naturally flows into the recovery boundary regions, thereby resulting in air in the flow delaying portions. In general, air in the flow delaying portion does not affect the flow of fluid. However, in the flow delaying model of FIG. 5D, no air is incorporated.

Another object of the present invention is to provide a flow acceleration model by which the rate of capillary flow in a particular region is increased. As is apparent from Equation (2) above, the rate of capillary flow increases as the value of the interfacial position (a) decreases. Accordingly, when the value of ΔP is fixed, the rate at which the interfacial position shifts decreases over time. The rate of capillary flow can be increased by increasing ΔP in accordance with the increase in the value of the interfacial position (a). However, only a few methods can be used to achieve this. However, when designing a microchannel for a diagnostic device, it may be required to accelerate the flow in a particular region in the microchannel, not to increase the rate at which the interfacial position shifts. In this case, the flow acceleration model developed in the present invention can provide powerful effects. The following equation based on the conservation of mass in a microfluidic device in which two microchannels having different cross-sections are connected is used as the flow equation in the present invention.
V₁·b₁·c₁=V₂·b₂ ·c₂ (5)
where V₁ denotes the flow rate in a region (D1), and V₂ denotes the flow rate in a region (D2) where the interface is located. As is apparent from Equation (5), V₁ can be increased by increasing V₂ or by increasing the primary length ratio (b₂/b₁) or the secondary length ratio (c₂/c₁) in the capillary tube. However, the increase in V₂ is limited because V₂ is a variable depending on Equation (2), whereas the primary length ratio (b₂/b₁) or the secondary length ratio (c₂/c₁) can be freely varied. A design feature of the flow acceleration model according to the present invention is a focus on the effects of the primary length ratio (b₂/b₁) or the secondary length ratio (c₂/c₁) on V₁.

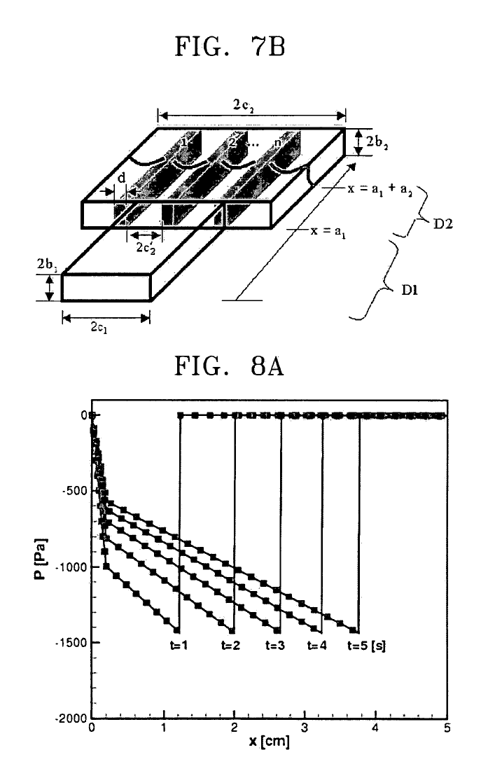

FIG. 7A is a schematic view of a microfluidic device using a flow acceleration model when the primary length ratio is maintained constant and the secondary length ratio is increased. The primary length ratio is maintained constant to minimize an instant delay in flow when the interface enters a region in which the secondary length ratio is increased. Here, it should be noted that the increase in the secondary length ratio (c₂/c₁) leads to a reduction in capillary pressure and a reduction in flow rate. To cope with these phenomena, the present invention provides a flow acceleration model with internal walls inserted in a region where the interface is located. An example of such a flow acceleration model according to the present invention is illustrated in FIG. 7B. Referring to FIG. 7B, as the number of internal walls increases, ΔP increases, and the flow rate increases. However, if too many internal walls are inserted, the resistive force of the walls increases, and the flow rate decreases. In other words, an optimal number of internal walls, which varies according to the thicknesses of the internal walls, has to be inserted to maximize V₁. The optimal number of internal walls according to the thicknesses of the internal walls can be theoretically estimated using Equation (5).

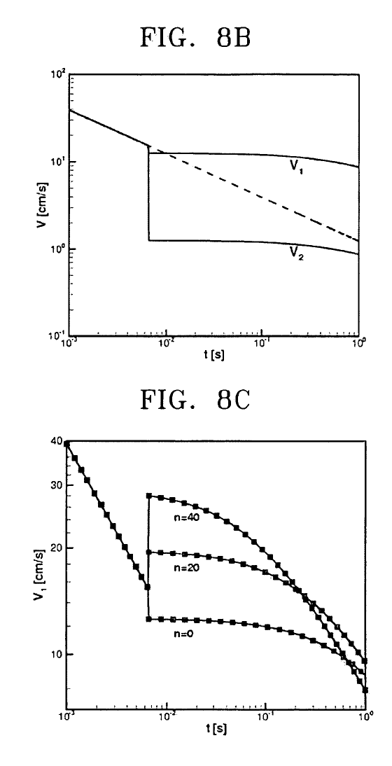

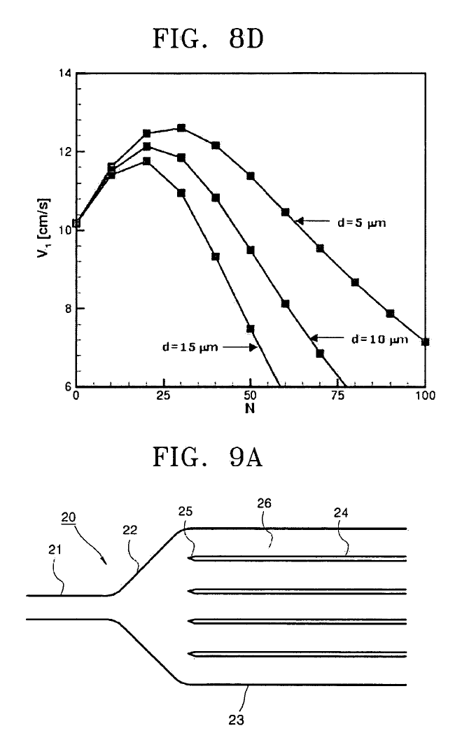

FIG. 8A is a graph of pressure distribution versus time at a₁=2000 μm, 2b₁=50 μm, 2c₁=200 μm, 2b₂=50 μm, 2c₂=2000 μm, γ=0.07N/m, and θ=π/3. In particular, under the calculation conditions in FIG. 2 for a simple straight channel, a₁=2000 μm was maintained, and the length was increased by ten times in the direction of the secondary length of the capillary tube. In FIG. 8A, the pressure abruptly varied in the region (D1) with a smaller fluid sectional area and slowly varied in the region (D2) with a larger fluid sectional area. The pressure gradient ratio between the two regions D1 and D2 is inversely proportional to the fluid sectional area ratio and the resistive force ratio between the two regions D1 and D2. In the calculation conditions of FIG. 8A, the variation in the resistive force term is relatively small, and thus the pressure gradient ratio is given as about 10:1. The flow rate ratio between the two regions is inversely proportional to the area ratio between the two regions. Accordingly, the flow rate in the region D1 with the smaller sectional area is maintained at 10 times the flow rate in the region D2 with the larger sectional area. Compared with the results in FIG. 2, in the conditions of FIG. 8A, the interfacial pressure decreased due to the increased fluid sectional area, and the pressure gradient in the region D2 became gentle. However, the pressure gradient in the region D1 became steep.

FIG. 8B is a graph of flow rate versus time in each region. In FIG. 8B, the dashed line denotes the results of calculation under the conditions of FIG. 2 where there was no variation in fluid sectional area, and the solid lines denote the results of calculation under the conditions where the sectional area was increased by 10 times. The increase in sectional area resulted in a reduction in the rate V₂ at which the interfacial position shifts and maintained the flow rate V₁ in the region D1 at a relatively large value. In other words, an effect of the increased sectional area of the capillary flow is the suppression of a reduction in the flow rate in the region with the smaller sectional area.

FIG. 8C is a graph of flow rate versus time in the region (D1) when internal walls are inserted in a flow acceleration model to raise the interfacial pressure. The calculation conditions were the same as for the results in FIG. 8A, and n internal walls each having a thickness of 10 μm were inserted. As is apparent from FIG. 8C, due to the insertion of the internal walls, the interfacial pressure increased, and the flow rate V₁ in the region D1 increased. However, when too many internal walls are inserted, the resistive force of the walls increases, and the flow rate decreases. As shown in FIG. 8C, when 20 internal walls are inserted, the flow rate increased over the entire time intervals. However, when 40 internal walls are inserted, the initial flow rate in the flow acceleration model increased, whereas the flow rate abruptly decreased due to the increased resistive force of the internal walls to a level lower than when no internal wall is inserted at t=1.

The optimal number of internal walls to be inserted in a given condition can be calculated using the equation model used in the present invention. The results are shown in FIG. 8D. The calculation conditions were the same as for the results in FIG. 8C, and the results were obtained at t=1. Referring to FIG. 8D, the optimal number of internal walls for maximizing the flow rate V₁ varies according to the thicknesses of the internal walls. In addition, as the thicknesses of the internal walls decreases, the flow rate is further increased. It was found through the theoretical analysis on the results that inserting internal walls with the smallest thicknesses possible increases the interfacial pressure and concurrently minimizes the internal resistive force and thus is most effective in accelerating the flow. However, the minimal thicknesses of internal walls are limited by the method of manufacturing the same. Therefore, in the present invention, a flow acceleration model was designed in consideration of the difficulty of manufacturing a microchannel.

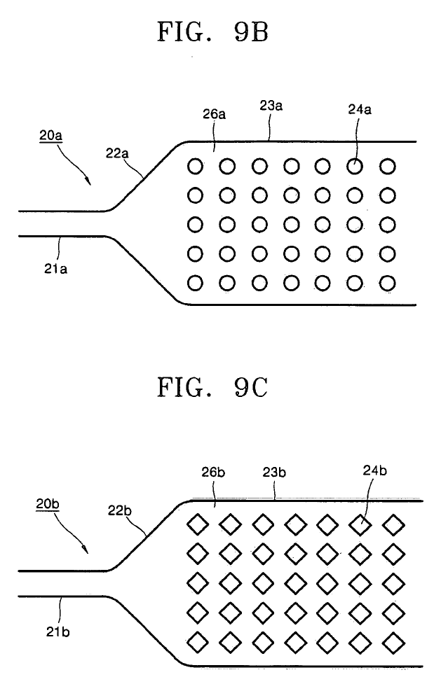

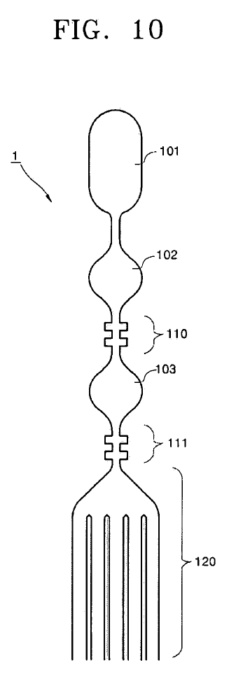

FIG. 9A is a schematic view of a microfluidic device using a flow acceleration model according to a first embodiment of the present invention. Referring to FIG. 9A, a microfluidic device 20 using a flow acceleration model according to the present invention includes an inflow portion 21 through which a microfluid flows and which has a first cross-section, a cross-section enlarging portion 22 into which the microfluid from the inflow portion 21 flows and which has cross-sections varying from the first cross-section to a second cross-section, which is larger than the first cross-section, and a predetermined length, and a flow accelerating portion 23 having substantially the same cross-section as the second cross-section and including at least one acceleration wall 24 arranged at intervals in the widthwise direction and extending along the lengthwise direction in which the microfluid flows, forming a plurality of acceleration channels 26.

To allow the microfluid flowing through the cross-section enlarging portion 22 to branch off into a plurality of channels, a front end 25 of the acceleration wall 24 near the cross-section enlarging portion 22 has a sharp shape. The acceleration wall 24 for increasing the capillary force is a thin plate arranged along the lengthwise direction of the flow accelerating portion 23. The flow accelerating portion 23 is divided into at least two acceleration channels 25 by the acceleration wall 24. The surfaces of the channels in the flow accelerating portion 23 may be treated to be hydrophilic.

In the above structure, the capillary flow induced through the inflow portion 21 continues through the cross-section enlarging portion 22 toward the plurality of acceleration channels 26. The capillary forces of the acceleration channels are large because the individual acceleration channels have small cross-sectional areas. The arrangement of the multiple acceleration channels increases the entire flow cross-sectional area and increases the capillary force. Therefore, the rate of the flow from the cross-section enlarging portion 22 into the acceleration channels 26 increases to a higher level than when no acceleration channel 26 is formed. As a result, the flow rate in the inflow portion 21 is markedly increased.

To minimize the resistive force against the capillary flow, it is preferred that the thickness of the inserted acceleration wall 24 is smaller and that the front end 25 of the acceleration wall 24 located in a region where the cross-section enlarging portion 22 and the acceleration channels 26 are connected has a sharp triangular shape. To suppress the resistance against the capillary flow, a connection portion between the inflow portion 21 and the cross-section enlarging portion 22 and a connection portion between the cross-section enlarging portion 22 and the acceleration channels 26 are rounded.

FIGS. 9B and 9C are schematic views of flow acceleration models according to second and third embodiments of the present invention, in which structures in various shapes are inserted to increase the capillary force. In FIGS. 9B and 9C, “a” and “b” are respectively added to the reference numerals denoting the constituent elements corresponding to the elements in the first embodiment illustrated in FIG. 9A. As shown in FIGS. 9B and 9C, structures in various shapes, for example, circular or rectangular structures, etc., instead of the acceleration wall 24, are inserted to increase the capillary force in a flow acceleration model. Such a structure may be manufactured in pillar shape extending from the bottom surface to the top surface of a channel or in a shape extending from the bottom surface to a predetermined height of a channel.

FIG. 10 is a schematic view of a diagnostic and analytical apparatus according to a first embodiment of the present invention, which uses flow delaying models and a flow acceleration method according to the present invention. Referring to FIG. 10, a diagnostic and analytical apparatus 1 according to a first embodiment of the present invention includes a sample injection unit 101 through which a sample to be analyzed is injected from the outside, a reaction unit 102, flow delaying models 110 and 111, a detection unit 103, and a flow acceleration model 120.

In the reaction unit 102, detection antibodies combined with a fluorescent dye are previously included. Capture antibodies are previously fixed to an internal surface of the detection unit 103. A sample supplied through the sample injection unit 101 of the diagnostic and analytical apparatus 1 is flowed through a microchannel into the reaction unit 102. In the reaction unit 102, an antigen in the sample reacts with the detection antibodies combined with the fluorescent dye and forms an antigen-antibody-dye complex. To ensure sufficient reaction time, the flow delaying models 110 and 111 are included. The reaction time in the reaction unit 102 is controlled according to the designs of the flow delaying models 110 and 111. Since the antibodies combined with the fluorescent dye in the reaction unit 102 are not fixed, the antigen-antibody-dye complexes derived as a result of the reaction in the reaction unit 102 are transferred to the detection unit 103 through the microchannel. The antigen-antibody-dye complexes react with the capture antibodies fixed to the surface of the detection unit 103 and are fixed in the detection unit 103. The reaction time in the detection unit 103 is controlled using the flow delaying models 110 and 111. After the reaction in the detection unit 103 is completed, the sample is moved to the flow acceleration model 120. The flow rate of the sample in the microchannel before the flow acceleration model 120 increases due to the function of the flow acceleration model 120. As a result, unnecessary substances or non-specifically bound antigen-antibody-dye complexes are removed from the detection unit 103.

Another object of the present invention is to provide a flow branch model by which a small amount of fluid is branched off to uniformly flow into a plurality of microfluidic devices using the above-described flow delaying technologies. As described above, using a microchannel with curved portions, capillary flow can be quantitatively delayed. When branching off a single stream of fluid to flow into a plurality of microchannels, the rates at which branch streams flow through the microchannels can be uniformly controlled by delaying the branch streams which are closer to the point of branching for a longer duration.

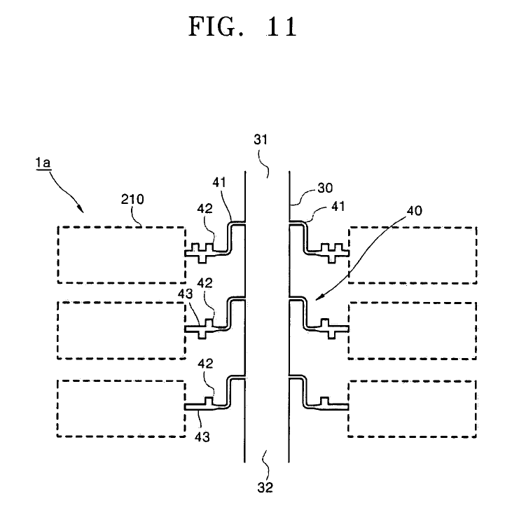

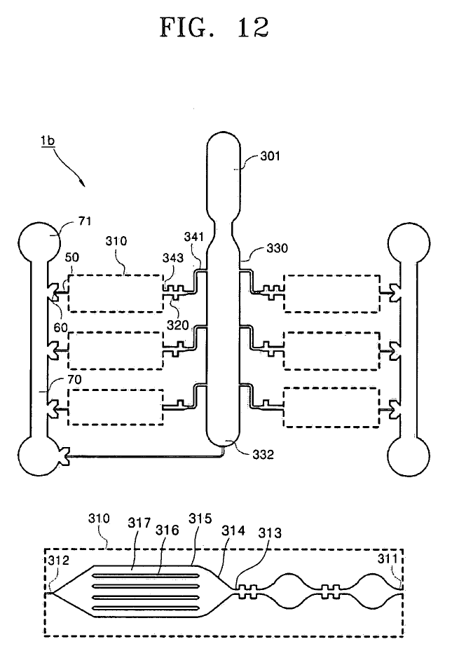

FIG. 11 is a schematic view of a diagnostic and analytical apparatus according to a second embodiment of the present invention, which includes a flow branch model using flow delaying models according to the present invention. Referring to FIG. 11, a diagnostic and analytical apparatus 1a including a plurality of microfluidic devices with microchannels through which a microfluid flows includes a main channel 30 along which the microfluid flows and a plurality of branch control units 40, which are connected to the main channel 30 and branch off the microfluid from the main channel 40 to flow into the plurality of microfluidic devices. Each of the branch control units 40 includes: a sub-channel 41, which is connected to the main channel 30 and has a first cross-section that is smaller than the cross-section of the main channel 30; a flow delaying portion 42, which is connected to the sub-channel 41, has a second cross-section that is larger than the first cross-section of the sub-channel 41 to reduce the interfacial curvature of the microfluid flowing through the sub-channel 41 by capillary force and the flow rate of the microfluid, and has a predetermined length extending in a direction in which the microfluid flows; and a flow recovery portion 43 into which the microfluid flows through the flow delaying portion 42 and which has a third cross-section that is smaller than the second cross-section of the flow delaying portion 42.

In the above structure, the fluid supplied from another microfluidic device or the outside through the inlet portion 31 is transferred to the main channel 30. The fluid transferred to the main channel 30 branches off to flow into the branch control units 40 and is transferred to the microfluidic devices 210 through the branch control units, which are constructed using flow delaying models. The branch control units 40 which are located further away from the inlet portion 31 provide a greater delaying effect. Therefore, when the fluid reaches an outlet portion 32 through the main channel 30, all the branch streams flowing through the individual sub-channels 41 almost substantially reach the corresponding microfluidic devices 210. Using the above-described flow branch model, a single stream of fluid injected through the inlet portion 31 can be uniformly branched off to flow through a plurality of microchannels. In the present embodiment, to allow the branch streams branched off from the microfluid flowing along the main channel 30 to almost simultaneously reach the corresponding microfluidic devices 210, a larger number of branch control units 40 are disposed upstream from the main channel 30 than downstream from the main channel 30. However, to allow the branch streams of the fluid flowing along the main channel 30 to almost simultaneously reach the corresponding microfluidic devices, sub-channels 41 which are located upstream from the main channel 30 may be configured with larger cross-sectional areas than sub-channels 41 which are located downstream from the main channel 30. Alternatively, sub-channels 41 which are located upstream from the main channel 30 may be configured with longer lengths than sub-channels 42 which are located downstream from the main channel 30. In addition, to increase the capillary force in the main channel 30 along which the microfluid flows such that the branch streams can almost simultaneously reach the corresponding microfluidic devices, at least one acceleration wall may be installed lengthwise in the main channel 30.

FIG. 12 is a schematic view of a multi-diagnostic and analytical apparatus according to a third embodiment of the preset invention using flow delaying models, a flow acceleration model, a flow branch model according to the present invention. Referring to FIG. 12, a multi-diagnostic and analytical apparatus 1b according to a third embodiment of the present invention includes a sample injection unit 301 through which a sample is supplied, a main channel 330, sub-channels 341 connected to the main channel 330, diagnostic units 310, which correspond to microfluidic devices, outlet microchannels 50 connected to the diagnostic units 310, flow delaying models 320 respectively located between the sub-channels 341 and the diagnostic units 310, flow stoppage channels 60 connected to ends of the outlet microchannels 50 to stop the microfluid from flowing, and a discharge channel 70, which is connected to the flow stoppage channels 60 and externally discharges air in the microfluidic devices through the outlet microchannels 50.

Each of the microfluidic devices, which correspond to the diagnostic units 310, may include a flow acceleration model according to the present invention. In particular, the flow acceleration model includes: an inflow portion 313 into which the microfluid from the sub-channel 341 flows and has a fourth cross-section; a cross-section enlarging portion 314 into which the microfluid from the inflow portion 313 flows and which has cross-sections varying from the fourth cross-section to a fifth cross-section, which is larger than the fourth cross-section, and a predetermined length; and a flow accelerating portion 315 having substantially the same cross-section as the fifth cross-section and including at least one acceleration wall arranged at intervals in the widthwise direction and extending along the lengthwise direction in which the microfluid flows, forming a plurality of acceleration channels.

In the above structure, the sample supplied through the sample injection unit 301 is transferred to the main channel 330. The sample transferred to the main channel 330 is transferred to the diagnostic units 341, which are microfluidic devices, through the sub-channels 341. A micro-channel 343 extending from each of the flow delaying models 320 is connected to an inlet 311 of the corresponding diagnostic unit 310. An outlet 312 of the diagnostic unit 310 is connected to the corresponding outlet microchannel 50. When the sample flowing along the main channel 330 reaches an end 332 of the main channel 330, the branch streams of the sample flowing along the sub-channels 341 almost simultaneously reach the corresponding diagnostic units 310 so that the sample can be uniformly distributed into the diagnostic units 310. The discharge channel 70 is connected to the outlet microchannels 50 to discharge air in the diagnostic units 310 out of the apparatus through a vent 71. To prevent the sample in the diagnostic units 310 from entering the discharge channel 70, the flow stoppage channels 60 are respectively inserted between the outlet microchannels 50 and the discharge channels 70. Since the flow stoppage channels 60 have large cross-sections while the outlet microchannels 50 have narrow widths, the sample stops flowing in the flow stoppage channels 60.

A multi-functional microfluidic device that can simultaneously perform multiple functions, for examples, immune reaction, polymerase chain reaction (PCR), DNA hybridization reaction, etc., on one kind of fluid can be implemented by replacing the plurality of diagnostic units 310 with different microfluidic devices.

A microchannel manufactured in the present invention may be manufactured by combining a plate with a depressed pattern and a plate with an embossed or depressed pattern. These plates may be formed of various materials, for example, a polymer, metal, silicon, glass, a printed circuit board (PCB), etc., with the polymer being preferred. Polymers that can be used in the present invention refer to plastics, such as PMMA (polymethylmethacrylate), PC (polycarbonate), COC (cycloolefin copolymer), PDMS (polydimethylsiloxane), PA (polyamide), PE (polyethylene), PP (polypropylene), PPE (polyphenylene ether), PS (polystyrene), POM (polyoxymethylene), PEEK (polyetherketone), PTFE (polytetrafluoroethylene), PVC (polyvinylchloride), PVDF (polyvinylidene fluoride), PBT (polybutyleneterephthalate), FEP (fluorinated ethylenepropylene), etc. These materials are widely used in molding processes, such as injection molding, hot embossing, or casting. The listed materials are inert, easy to handle, inexpensive, and disposable, and thus are suitable for manufacturing microchannels.

In a method of manufacturing a microchannel according to the present invention, a template plate with an embossed pattern corresponding to the shape of the microchannel is manufactured, a first plate with a depressed pattern is molded using the template plate, and a second plate, which may be plate or may have an embossed or depressed pattern, is manufactured. The surfaces of the two plates are hydrophilically treated, and the first plate with the depressed pattern is bonded to the second plate.

Although in the embodiments described above at least one acceleration wall is installed in a flow accelerating portion, no acceleration wall may be installed in the flow accelerating portion provided that the flow can be accelerated by increasing the cross-sectional area of the flow acceleration model to be larger than the inlet portion.

Although in the above embodiments microfluidic devices with rectangular cross-sections have been described, the rectangular cross-sectional shapes are only for illustrative purposes, and the microfluidic devices may have various cross-sectional shapes, for example, circular cross-sectional shapes.

As described above, in a microfluidic device and a diagnostic and analytical apparatus using the same according to the present invention, the flow of a very small volume of fluid can be quantitatively regulated through a channel having a particular design that can induce spontaneous flow by capillary force without additional manipulation processes and energy requirement. The microfluidic device and the diagnostic and analytical apparatus can be easily manufactured and can be easily used.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A microfluidic device having a microchannel through which a microfluid flows, the device comprising:
an inlet portion through which the microfluid flows and which has a first cross-section and a predetermined length;
a flow delaying portion which is located adjacent to the inlet portion to allow the microfluid from the inlet portion to enter, has a second cross-section that is larger than the first cross-section of the inlet portion to reduce the interfacial curvature of the microfluid entering from the inlet portion by capillary force and the flow rate of the microfluid, and has a predetermined length extending in a direction in which the microfluid flows; and
a flow recovery portion which is located adjacent to the flow delaying portion to allow the microfluid from the flow delaying portion to enter, and has a third cross-section that is smaller than the second cross-section of the flow delaying portion and a predetermined length.

2. The microfluidic device of claim 1, wherein the predetermined length of the flow delaying portion is smaller than a width of the flow delaying portion.

3. The microfluidic device of claim 1, wherein the first cross-section is fixed through the inlet portion, the second cross-section is fixed through the flow delaying portion, and the third cross-section is fixed through the flow recovery portion.

4. The microfluidic device of claim 1, wherein lengthwise walls of the inlet portion and widthwise walls of the flow delaying portion form an angle in a range of 45-90 degrees.

5. The microfluidic device of claim 1, wherein the second cross-section of the flow delaying portion has the same height as the first cross-section of the inlet portion and a width that is larger than the first cross-section of the inlet portion.

6. The microfluidic device of claim 5, wherein the width of the second cross-section of the flow delaying portion is three times larger than a width of the first cross-section of the inlet portion.

7. The microfluidic device of claim 1, wherein the second cross-section of the flow delaying portion has the same width as the first cross-section of the inlet portion and a height that is larger than the first cross-section of the inlet portion.

8. The microfluidic device of claim 7, wherein the height of the second cross-section of the flow delaying portion is two times larger than the first cross-section of the inlet portion, and upper surfaces of the second cross-section and the first cross-section are on the same plane.

9. The microfluidic device of claim 1, wherein the first cross-section of the flow delaying portion and the third cross-section of the flow recovery portion are the same.

10. A diagnostic and analytical apparatus using the microfluidic device of claim 1.

11. The microfluidic device of claim 1, further comprising:
an inflow portion into which the microfluid from the flow recovery portion flows and which has a fourth cross-section;
a cross-section enlarging portion into which the microfluid from the inflow portion flows and which has cross-sections varying from the fourth cross-section to a fifth cross-section, which is larger than the fourth cross-section, and a predetermined length; and
a flow accelerating portion which has substantially the same cross-section as the fifth cross-section.

12. The microfluidic device of claim 11, wherein the flow accelerating portion includes at least one acceleration wall arranged at interval in the widthwise direction and extending along the lengthwise direction in which the microfluid flows, forming a plurality of acceleration channels.

13. The microfluidic device of claim 11, wherein a front end of the acceleration wall near the cross-section enlarging portion is shape such that the microfluid incoming from the cross-section enlarging portion can easily branch off to flow into the plurality of acceleration channels.

14. The microfluidic device of claim 12, wherein the acceleration wall is a thin plate arranged in the lengthwise direction of the flow accelerating portion.

15. The microfluidic device of claim 11, wherein surfaces of the acceleration channels in the flow accelerating portion are hydrophilically treated.

16. The microfluidic device of claim 11, wherein the inflow portion is a channel connected to a detection unit in which capture antibodies that are reacted with the microfluid are fixed.

17. A diagnostic and analytical apparatus using the microfluidic device of claim 11.

18. A diagnostic and analytical apparatus including a plurality of microfluidic devices with microchannels through which a microfluid flows, the apparatus comprising:
a main channel through which the microfluid flows; and
a plurality of branch control units which are connected to the main channel and branch off the microfluid from the main channel to flow into the plurality of microfluidic devices,
wherein each of the branch control units comprises:
a sub-channel which is connected to the main channel and has a first cross-section that is smaller than a cross-section of the main channel;
a flow delaying portion which is connected to the sub-channel to allow the microfluid from the sub-channel to enter, has a second cross-section that is larger than the first cross-section of the sub-channel to reduce the interfacial curvature of the microfluid entering from the sub-channel by capillary force and the flow rate of the microfluid, and has a predetermined length extending in a direction in which the microfluid flows; and
a flow recovery portion into which the microfluid from the flow delaying portion flows and has a third cross-section that is smaller than the second cross-section of the flow delaying portion.

19. The diagnostic and analytical apparatus of claim 18, wherein the sub-channels which are located upstream from the main channel have larger cross-sectional areas than the sub-channels which are located downstream from the main channel such that the microfluid flowing along the main channel can almost simultaneously reach the individual microfluidic channels.

20. The diagnostic and analytical apparatus of claim 18, wherein a larger number of branch control units are located upstream from the main channel than downstream from the main channel such that the microfluid flowing along the main channel can almost simultaneously reach the individual microfluidic channels.

21. The diagnostic and analytical apparatus of claim 18, wherein the sub-channels which are located upstream from the main channel have longer lengths than the sub-channels which are located downstream from the main channel such that the microfluid flowing along the main channel can almost simultaneously reach the individual microfluidic channels.

22. The diagnostic and analytical apparatus of claim 18, wherein at least one acceleration wall is installed lengthwise in the main channel to increase the capillary force of the microfluid flowing along the main channel such that the microfluid can almost simultaneously reach the individual microfluidic channels.

23. The diagnostic and analytical apparatus of claim 18, further comprising:
outlet microchannels which are respectively connected to the microfluidic devices;
flow stoppage channels which are respectively connected to ends of the outlet microchannels to stop the microfluid from flowing; and
a discharge channel which is connected to the flow stoppage channels and externally discharges air in the microfluidic devices through the outlet microchannels.

24. The diagnostic and analytical apparatus of claim 18, wherein each of the microfluidic devices comprises:
an inlet portion into which the microfluid from the corresponding sub-channel flows and which has a fourth cross-section and a predetermined length;
a flow delaying portion which is located adjacent to the inlet portion to allow the microfluid from the inlet portion to enter, has a fifth cross-section that is larger than the first cross-section of the inlet portion to reduce the interfacial curvature of the microfluid entering from the inlet portion by capillary force and the flow rate of the microfluid, and has a predetermined length extending in the direction in which the microfluid flows; and
a flow recovery portion which is located adjacent to the flow delaying portion to allow the microfluid from the flow delaying portion to enter, and has a sixth cross-section that is smaller than the fifth cross-section of the flow delaying portion and a predetermined length.

25. The diagnostic and analytical apparatus of claim 18, wherein each of the microfluidic devices comprises:
an inflow portion into which the microfluid from the flow recovery portion flows and which has a fourth cross-section;
a cross-section enlarging portion into which the microfluid from the inflow portion flows and which has cross-sections varying from the fourth cross-section to a fifth cross-section, which is larger than the fourth cross-section, and a predetermined length; and
a flow accelerating portion which has substantially the same cross-section as the fifth cross-section.

26. The diagnostic and analytical apparatus of claim 25, wherein the inflow portion is a channel connected to a detection unit in which capture antibodies that are reacted with the microfluid flowing through the flow recovery portion are fixed.
